(19) United States
(12) Patent Application Publication
(10) Pub. No.: US 2026/0142371 A1
(43) Pub. Date: May 21, 2026

(54) SWITCHABLE ANTENNA SYSTEM FOR TWO-PIECE DEVICE

(71) Applicant: ASUSTeK COMPUTER INC., Taipei (TW)

(72) Inventors: Chien-Ming Hsu, Taipei (TW); Chun-Chieh Su, Taipei (TW)

(21) Appl. No.: 19/348,860

(22) Filed: Oct. 3, 2025

(30) Foreign Application Priority Data
Nov. 19, 2024 (TW) 113144520

(51) Int. Cl. H01Q 3/24; H01Q 5/20

(52) U.S. Cl. CPC H01Q 3/247; H01Q 5/20

(57) ABSTRACT

A switchable antenna system for a two-piece device is provided. The switchable antenna system includes a first antenna, a second antenna, a third antenna, a first wireless communication module, a second wireless communication module, a first switching circuit, a second switching circuit, and a control device. In the switchable antenna system, the first antenna, the second antenna, and the third antenna support a wireless communication frequency band and a 2.4GHZ proprietary frequency band. The control device is electrically connected to the first wireless communication module, the second wireless communication module, the first switching circuit, and the second switching circuit to control the first switching circuit and the second switching circuit to electrically connect the first wireless communication module to two of the first antenna, the second antenna, and the third antenna selectively via the first switching circuit and the second switching circuit.

### CROSS-REFERENCE TO RELATED APPLICATION

This application claims the priority benefit of Taiwan application serial No. 113144520, filed on November 19, 2024. The entirety of the above-mentioned patent application is hereby incorporated by reference herein and made a part of specification.

### BACKGROUND OF THE INVENTION

### FIELD OF THE INVENTION

The invention relates to a switchable antenna system for a two-piece device.

### DESCRIPTION OF THE RELATED ART

Most wearable devices, such as virtual reality (VR), augmented reality (AR), and mixed reality (MR) devices, are one-piece design. All components, such as a processor, a wireless communication chip, antennas, and cameras, are integrated into a headset of the wearable device. The wearable device usually includes three antennas, that is, two Wi-Fi antennas and one Nordic 2.4 GHz proprietary antenna. Moreover, no switch mechanism is configured of the antennas.

However, if the antennas used in the one-piece wearable devices--that is, one Nordic 2.4 GHz proprietary antenna supporting a joystick and two Wi-Fi antennas-- directly adapt to the two-piece wearable devices, such as virtual reality (VR), augmented reality (AR), and mixed reality (MR) wearable devices without configuring switch mechanisms at the antennas, the antennas are easily interfered, and signal transmission and reception performance are poor.

### BRIEF SUMMARY OF THE INVENTION

A switchable antenna system for a two-piece device is provided. The two-piece device includes a detachable host and a detachable helmet. The detachable host is electrically connected to the detachable helmet. The switchable antenna system comprises: a first antenna, configured on the detachable host, the first antenna supports a wireless communication frequency band and a 2.4GHZ proprietary frequency band. A second antenna, configured on the detachable host, the second antenna supports the wireless communication frequency band and the 2.4GHZ proprietary frequency band. A third antenna, configured on the detachable helmet, the third antenna supports the wireless communication frequency band and the 2.4GHZ proprietary frequency band. A first wireless communication module, configured on the detachable host. A second wireless communication module, configured on the detachable helmet. The second wireless communication module is adapted to be electrically connected to a joystick via the 2.4GHZ proprietary frequency band. A first switching circuit, electrically connected to the first antenna, the second antenna, and the first wireless communication module. A second switching circuit, electrically connected to the first switching circuit, the third antenna, the second wireless communication module, and the first switching circuit. A control device, electrically connected to the first wireless communication module, the second wireless communication module, the first switching circuit, and the second switching circuit, to control the first switching circuit, and the second switching circuit. The control device controls the first switching circuit and the second switching circuit to electrically connect the first wireless communication module to two of the first antenna, the second antenna, and the third antenna selectively via the first switching circuit and the second switching circuit.

In summary, a switchable antenna system for a two-piece device is provided herein. The most suitable antenna combination is selected according to scenario-based switching or dynamic switching in different usage states. Signal strength of antennas in signal transmission and reception are dynamically improved. Thus, antennas have a good performance in different usage scenarios. Therefore, an optimal antenna combination of the switchable antenna system for a two-piece device is selected adaptively. Furthermore, different antenna combinations are switched and selected to reach the best communication quality according to the position of the detachable host and whether the joystick is in use.

### BRIEF DESCRIPTION OF THE DRAWINGS

FIG. 1 is a block diagram showing a switchable antenna system for a two-piece device according to an embodiment of the invention.

FIG. 2 is a schematic diagram showing a two-piece device of which a joystick is in use and a detachable host is configured on a rear end of a detachable helmet according to an embodiment of the invention.

FIG. 3 is a schematic diagram showing a two-piece device of which a joystick is in use and a detachable host is worn on a body of a user according to an embodiment of the invention.

FIG. 4 is a schematic diagram showing a switchable antenna system of which a first antenna and a second antenna are electrically connected to a first wireless communication module and a third antenna is electrically connected to a second wireless communication module according to an embodiment of the invention.

FIG. 5 is a schematic diagram showing a switchable antenna system of which a first antenna and a third antenna are electrically connected to a first wireless communication module and a second antenna is electrically connected to a second wireless communication module according to an embodiment of the invention.

FIG. 6 is a schematic diagram showing a switchable antenna system of which a second antenna and a third antenna are electrically connected to a first wireless communication module and a first antenna is electrically connected to a second wireless communication module according to an embodiment of the invention.

FIG. 7 is a schematic diagram showing a two-piece device of which a joystick is not in use and a detachable host is configured on a rear end of the detachable helmet according to an embodiment of the invention.

FIG. 8 is a schematic diagram showing a two-piece device of which a joystick is not in use and a detachable host is worn on a body of a user according to an embodiment of the invention.

### DETAILED DESCRIPTION OF THE EMBODIMENTS

Embodiments of the invention are illustrated accompanying diagrams. In addition, some components or structures are omitted in the diagrams to clearly show technical features of the invention. In the diagrams, same or similar numerals denote the same or similar components or circuits. Terms such as "first", "second" are used to describe various components, parts, regions or functions to distinguish one component, part, region or function from another.

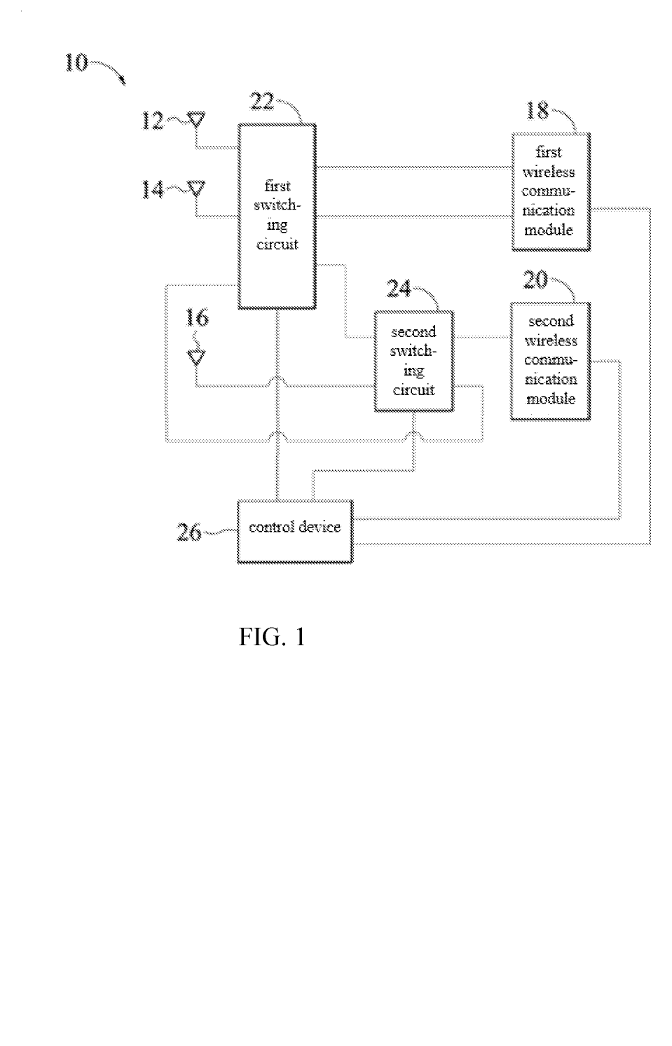

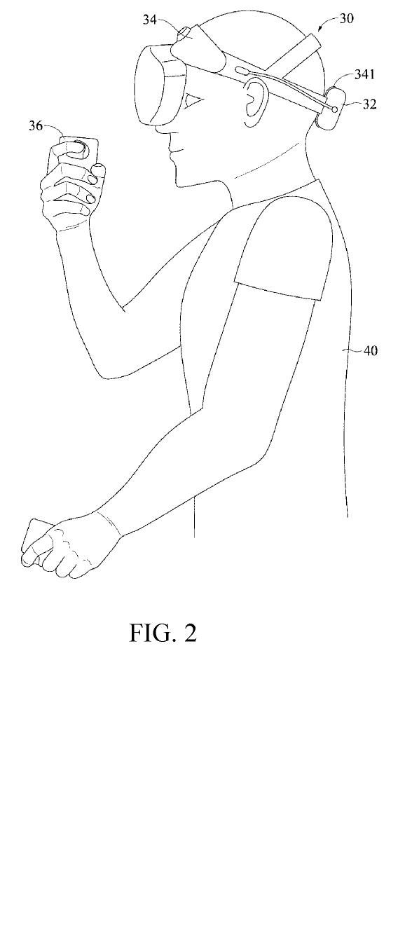

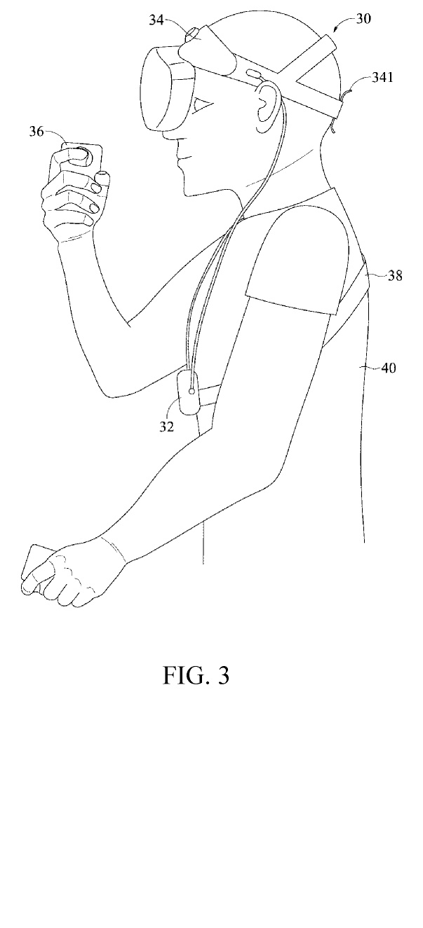

Please refer to FIG. 1, FIG. 2, and FIG. 3. A switchable antenna system for a two-piece device 10 includes a first antenna 12, a second antenna 14, a third antenna 16, a first wireless communication module 18, a second wireless communication module 20, a first switching circuit 22, a second switching circuit 24, and a control device 26. The two-piece device 30 is adapted to be worn on a body of a user 40. The two-piece device 30 includes a detachable host 32 and a detachable helmet 34. The detachable host 32 is electrically connected to the detachable helmet 34. The detachable helmet 34 is worn on the head of the user 40. The detachable helmet 34 is a helmet with a display. The detachable host 32 is configured on a rear end of the detachable helmet 34 or worn on the body of the user 40 according to requirements. In an embodiment, the two-piece device 30 is a two-piece virtual reality (VR) device, a two-piece augmented reality (AR) device, or a two-piece mixed reality (MR) device.

In the switchable antenna system 10, the first antenna 12 is configured on the detachable host 32. The first antenna 12 supports a wireless communication frequency band (WiFi frequency band) and a 2.4GHZ proprietary frequency band (Nordic 2.4 GHz Proprietary RF Band). The second antenna 14 is also configured on the detachable host 32. The second antenna 14 supports the wireless communication frequency band and the 2.4GHZ proprietary frequency band. The third antenna 16 is configured on the detachable helmet 34. The third antenna 16 supports the wireless communication frequency band and the 2.4GHZ proprietary frequency band. The first antenna 12, the second antenna 14, and the third antenna 16 operate at frequency bands 2.4 to 2.5 GHz and 5.15 to 7.125 GHz. The first wireless communication module 18 is configured on the detachable host 32 to transmit and receive wireless signals in the wireless communication frequency band. The second wireless communication module 20 is configured on the detachable helmet 34 to transmit and receive wireless signals in the 2.4GHZ proprietary frequency band to electrically connect the second wireless communication module 20 to a joystick 36 via the 2.4GHZ proprietary frequency band. A first terminal of the first switching circuit 22 is electrically connected to the first antenna 12, the second antenna 14 and a second terminal of the second switching circuit 24. The second terminal of the first switching circuit 22 is electrically connected to the first wireless communication module 18 and the first terminal of the second switching circuit 24. Consequently, the first antenna 12, the second antenna 14, and the third antenna 16 are electrically connected to the first wireless communication module 18 selectively. The first terminal of the second switching circuit 24 is electrically connected to the second terminal of the first switching circuit 22 and the third antenna 16. The second terminal of the second switching circuit 24 is electrically connected to the second wireless communication module 20 and the first terminal of the first switching circuit 22. Consequently, the first antenna 12, the second antenna 14, and the third antenna 16 are electrically connected to the second wireless communication module 20 selectively. The control device 26 is configured on the detachable host 32 and electrically connected to the first wireless communication module 18, the second wireless communication module 20, the first switching circuit 22, and the second switching circuit 24 to control the first switching circuit 22 and the second switching circuit 24. Then, the first wireless communication module 18 is electrically connected to two of the first antenna 12, the second antenna 14, and the third antenna 16 selectively via the first switching circuit 22 and the second switching circuit 24.

In an embodiment, the control device 26 of the detachable host 32 executes a detection mechanism to detect a position of the detachable host 32, and controls the first switching circuit 22 and the second switching circuit 24 according to whether the detachable host 32 is configured on the rear end of the detachable helmet 34 or worn on the body of the user 40.

In an embodiment, the control device 26 is one or a combination of a central processing unit (CPU), other general-purpose or special-purpose microprocessors, microcontrollers, micro control units (MCUs), digital signal processors (DSPs), programmable controllers, application specific integrated circuits (ASICs), and other similar components, which is not limited herein.

In the embodiment, different combinations of antennas are switched according to the position of the detachable host 32 and whether the joystick 36 is in use to select the antennas at different usage states dynamically.

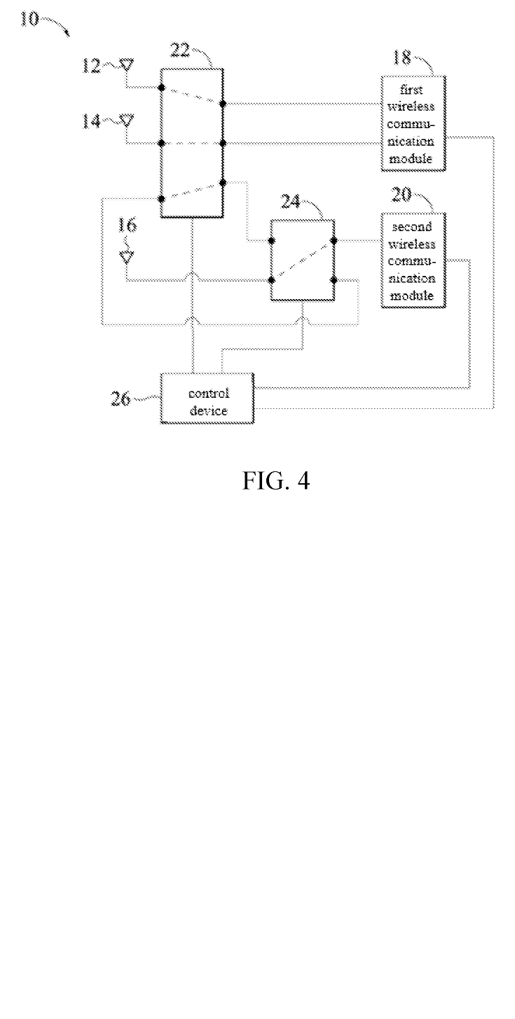

Please refer to FIG. 2 and FIG. 4. In the switchable antenna system 10, the control device 26 determines the detachable host 32 is configured on the rear end of the detachable helmet 34 and the joystick 36 is in use, the control device 26 controls the first switching circuit 22 and the second switching circuit 24 to electrically connect the first wireless communication module 18 to the first antenna 12 and the second antenna 14 selectively via the first switching circuit 22, and controls the second wireless communication module 20 to be electrically connected to the third antenna 16 selectively via the second switching circuit 24. Then, the first antenna 12 and the second antenna 14 are served as Wi-Fi antennas, and the third antenna 16 is served as a Nordic 2.4G proprietary antenna. Consequently, the first wireless communication module 18 transmits and receives wireless signals via the first antenna 12 and the second antenna 14, and the second wireless communication module 20 is connected to the joystick 36 via the third antenna 16. In the embodiment, when the detachable host 32 is configured on the rear end of the detachable helmet 34 and the joystick 36 is in use, both the third antenna 16 configured on the detachable helmet 34 and the joystick 36 are configured on a front side of the user 40. Among the joystick 36 and each of the three antennas, a distance between the joystick 36 and the third antenna 16 is shortest without any blocking. Thus, the communication state of the third antenna 16 with the joystick 36 is better than that of the first antenna 12 and the second antenna 14 at the detachable host 32.

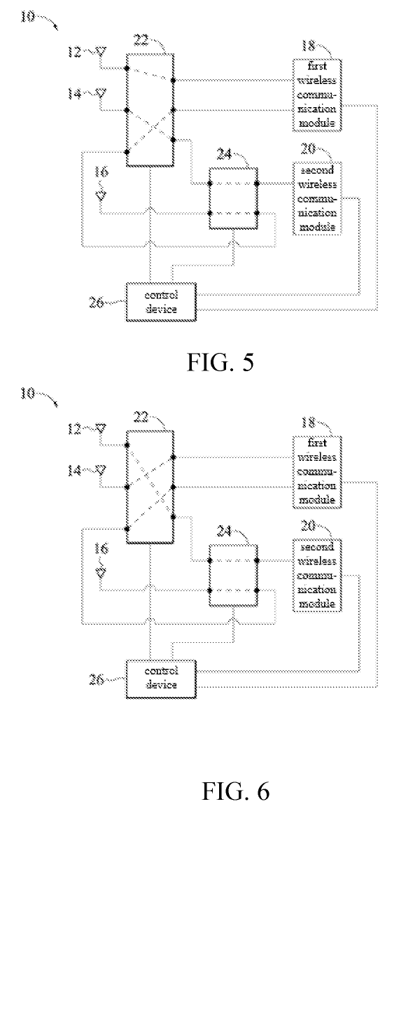

Please refer to FIG. 3, FIG. 4 and FIG. 6. In the switchable antenna system 10, the control device 26 determines whether the detachable host 32 is worn on the body of the user 40 and the joystick 36 is in use, the first wireless communication module 18 and the second wireless communication module 20 transfer results of the signal strength of the first antenna 12, the second antenna 14, and the third antenna 16 to the control device 26, respectively. The control device 26 determines the antenna with the highest signal strength and controls the switch of the first switching circuit 22 and the second switching circuit 24 accordingly. The control device 26 controls the second wireless communication module 20 to be electrically connected to one of the first antenna 12, the second antenna 14, and the third antenna 16 with a highest signal strength selectively via the first switching circuit 22 and the second switching circuit 24. The antenna with the highest signal strength is preferentially used as a Nordic 2.4G proprietary antenna. Furthermore, the control device 26 controls the first wireless communication module 18 to be electrically connected to the other two antennas selectively via the first switching circuit 22 and the second switching circuit 24. The other two antennas are served as WiFi antennas. As shown in FIG. 4, when the third antenna 16 has the highest signal strength, the control device 26 controls the switch of the first switching circuit 22 and the second switching circuit 24 to electrically connect the first wireless communication module 18 to the first antenna 12 and the second antenna 14 via the first switching circuit 22. The first antenna 12 and the second antenna 14 are served as WiFi antennas. The control device 26 controls the second wireless communication module 20 to be electrically connected to the third antenna 16 via the second switching circuit 24. The third antenna 16 is served as the Nordic 2.4G proprietary antenna and connected to the joystick 36. As shown in FIG. 5, when the second antenna 14 has the highest signal strength, the control device 26 controls the switch of the first switching circuit 22 and the second switching circuit 24 to electrically connect the first wireless communication module 18 to the first antenna 12 and the third antenna 16 via the first switching circuit 22 and the second switching circuit 24. The first antenna 12 and the third antenna 16 are served as WiFi antennas. The control device 26 controls the second wireless communication module 20 to be electrically connected to the second antenna 14 via the first switching circuit 22 and the second switching circuit 24. The second antenna 14 is served as the Nordic 2.4G proprietary antenna and is connected to the joystick 36. As shown in FIG. 6, when the first antenna 12 has the highest signal strength, the control device 26 controls the switch of the first switching circuit 22 and the second switching circuit 24 to electrically connect the first wireless communication module 18 to the second antenna 14 and the third antenna 16 via the first switching circuit 22 and the second switching circuit 24. The second antenna 14 and the third antenna 16 are served as WiFi antennas. The control device 26 controls the second wireless communication module 20 to be electrically connected to the first antenna 12 via the first switching circuit 22 and the second switching circuit 24. The first antenna 12 is served as the Nordic 2.4G proprietary antenna and connected to the joystick 36. Therefore, the second wireless communication module 20 has the priority to use the antenna with the highest signal strength to be connected with the joystick 36.

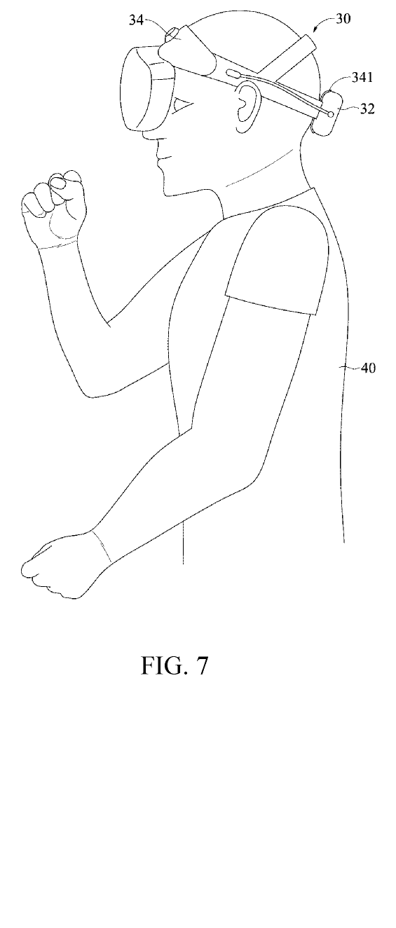

Please refer to FIG. 4, FIG. 6 and FIG. 7. In the switchable antenna system 10, the control device 26 determines the detachable host 32 is configured on the rear end of the detachable helmet 34 and the joystick 36 is not in use. Since the joystick 36 is not in use, in an embodiment, the first antenna 12, the second antenna 14, and the third antenna 16 are allowed to be served as WiFi antennas. The control device 26 controls the switch of the first switching circuit 22 and the second switching circuit 24 according to signal strength of the antennas to electrically connect the first wireless communication module 18 to two antennas with higher signal strength of the first antenna 12, the second antenna 14, and the third antenna 16 selectively via the first switching circuit 22 and the second switching circuit 24. As shown in FIG. 4, when the signal strength of the first antenna 12 and the second antenna 14 has higher signal strength, the control device 26 controls the switch of the first switching circuit 22 and the second switching circuit 24 to electrically connect the first wireless communication module 18 to the first antenna 12 and the second antenna 14 via the first switching circuit 22. The first antenna 12 and the second antenna 14 are served as WiFi antennas. As shown in FIG. 5, when the first antenna 12 and the third antenna 16 has higher signal strength, the control device 26 controls the switch of the first switching circuit 22 and the second switching circuit 24 to electrically connect the first wireless communication module 18 to the first antenna 12 and the third antenna 16 via the first switching circuit 22 and the second switching circuit 24. The first antenna 12 and the third antenna 16 are served as WiFi antennas. As shown in FIG. 6, when the second antenna 14 and the third antenna 16 has higher signal strength, the control device 26 controls the switch of the first switching circuit 22 and the second switching circuit 24 to electrically connect the first wireless communication module 18 to the second antenna 14 and the third antenna 16 via the first switching circuit 22 and the second switching circuit 24. The second antenna 14 and the third antenna 16 are served as WiFi antenna.

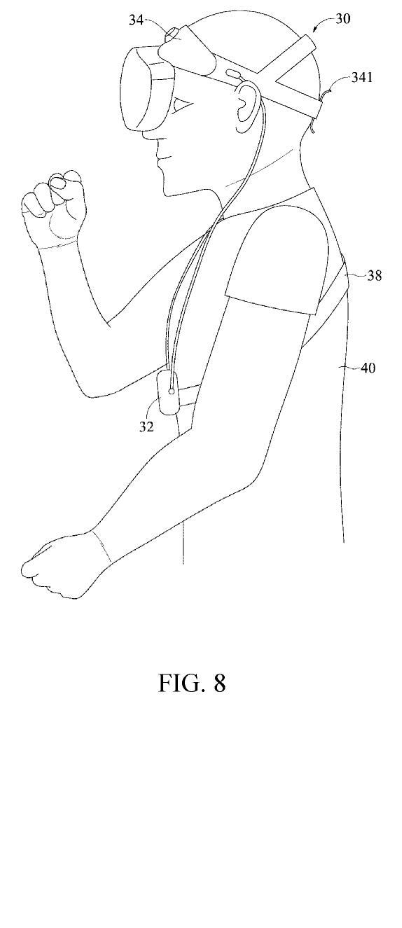

Please refer to FIG. 4, FIG. 6 and FIG. 8. In the switchable antenna system 10, the control device 26 determines the detachable host 32 is worn on the body of the user 40 and the joystick 36 is not in use. Since the joystick 36 is not in use, the first antenna 12, the second antenna 14, and the third antenna 16 are allowed to be served as WiFi antenna. The control device 26 controls the switch of the first switching circuit 22 and the second switching circuit 24 according to signal strength of the antennas to electrically connect the first wireless communication module 18 to two antennas with higher signal strength of the first antenna 12, the second antenna 14, and the third antenna 16 selectively via the first switching circuit 22 and the second switching circuit 24. As shown in FIG. 4, when the signal strength of the first antenna 12 and the second antenna 14 has higher signal strength, the first antenna 12 and the second antenna 14 are served as WiFi antenna. As shown in FIG. 5, when the first antenna 12 and the third antenna 16 has higher signal strength, the first antenna 12 and the third antenna 16 are served as WiFi antennas. As shown in FIG. 6, when the second antenna 14 and the third antenna 16 has higher signal strength, the second antenna 14 and the third antenna 16 are served as WiFi antennas.

Please refer to FIG. 1, FIG. 2 and FIG. 3. In an embodiment, a carrier seat 341 is configured on the rear end of the detachable helmet 34. In an embodiment, the carrier seat 341 is a fastening seat. The detachable host 32 is adapted to be installed at the carrier seat 341. In an embodiment, an electronic switch (not shown) is configured on the carrier seat 341 to allow the control device 26 to determine whether the detachable host 32 is configured on the carrier seat 341 at the rear end of the detachable helmet 34. Consequently, the control device 26 determines the position of the detachable host 32 via a detection mechanism of the electronic switch to select a suitable antenna combination. Any detection mechanism that determines the position of the detachable host 32 is applicable, which is not limited herein.

Please refer to FIG. 1, FIG. 3 and FIG. 8. In an embodiment, the detachable host 32 is worn on the body of the user 40 via a strap 38. When the detachable host 32 is worn on the body of the user 40 via the strap 38, the position of the detachable host 32 is far away from the detachable helmet 34. After the control device 26 determines the position of the detachable host 32, the combination of antennas is selected.

In summary, a switchable antenna system for a two-piece device is provided in embodiments. The most suitable antenna combination is selected according to scenario-based switching or dynamic switching in different usage states. Signal strength of antennas in signal transmission and reception are dynamically improved. Thus, antennas have a good performance in different usage scenarios. Therefore, an optimal antenna combination of the switchable antenna system for a two-piece device is selected adaptively. Furthermore, different antenna combinations are selected according to the position of the detachable host and whether the joystick is in use, and thus the best communication quality is obtained.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A switchable antenna system for a two-piece device, the two-piece device includes a detachable host and a detachable helmet, the detachable host is electrically connected to the detachable helmet, the switchable antenna system comprising:
a first antenna, configured on the detachable host, the first antenna supports a wireless communication frequency band and a 2.4GHZ proprietary frequency band;
a second antenna, configured on the detachable host, the second antenna supports the wireless communication frequency band and the 2.4GHZ proprietary frequency band;
a third antenna, configured on the detachable helmet, the third antenna supports the wireless communication frequency band and the 2.4GHZ proprietary frequency band;
a first wireless communication module, configured on the detachable host;
a second wireless communication module, configured on the detachable helmet, the second wireless communication module is adapted to be electrically connected to a joystick via the 2.4GHZ proprietary frequency band;
a first switching circuit, electrically connected to the first antenna, the second antenna, and the first wireless communication module;
a second switching circuit, electrically connected to the first switching circuit, the third antenna, the second wireless communication module, and the first switching circuit; and
a control device, electrically connected to the first wireless communication module, the second wireless communication module, the first switching circuit, and the second switching circuit, the control device controls the first switching circuit and the second switching circuit to electrically connect the first wireless communication module to two of the first antenna, the second antenna, and the third antenna selectively via the first switching circuit and the second switching circuit.

2. The switchable antenna system for the two-piece device according to claim 1, wherein the control device controls the first switching circuit and the second switching circuit according to whether the detachable host is configured on a rear end of the detachable helmet or worn on a body of a user.

3. The switchable antenna system for the two-piece device according to claim 1, wherein when the control device determines the detachable host is configured on the rear end of the detachable helmet and the joystick is in use, the control device controls to switch the first switching circuit and the second switching circuit to electrically connect the first wireless communication module to the first antenna and the second antenna selectively via the first switching circuit, and to electrically connect the second wireless communication module to the third antenna selectively via the second switching circuit.

4. The switchable antenna system for the two-piece device according to claim 2, wherein when the control device determines the detachable host is worn on the body of the user and the joystick is in use, the control device controls a switch of the first switching circuit and the second switching circuit to electrically connect the second wireless communication module to one of the first antenna, the second antenna, and the third antenna with a highest signal strength selectively via the first switching circuit and the second switching circuit, and the control device controls the first wireless communication module to be electrically connected to other two antennas of the first antenna, the second antenna, and the third antenna selectively via the first switching circuit and the second switching circuit.

5. The switchable antenna system for the two-piece device according to claim 2, wherein when the control device determines the detachable host configured on the rear end of the detachable helmet and the joystick is not in use, the control device controls a switch of the first switching circuit and the second switching circuit to electrically connect the first wireless communication module to two of the first antenna, the second antenna, and the third antenna with higher signal strength selectively via the first switching circuit and the second switching circuit.

6. The switchable antenna system for the two-piece device according to claim 2, wherein the control device determines the detachable host is configured on a user and the joystick is not in use, the control device controls a switch of the first switching circuit and the second switching circuit to electrically connect the first wireless communication module to two of the first antenna, the second antenna, and the third antenna with higher signal strength selectively via the first switching circuit and the second switching circuit.

7. The switchable antenna system for the two-piece device according to claim 2, wherein a carrier seat is configured on the rear end of the detachable helmet, and the detachable host is adapted to be installed at the carrier seat.

8. The switchable antenna system for the two-piece device according to claim 7, wherein an electronic switch is configured on the carrier seat to allow the control device to determine whether the detachable host is configured on the rear end of the detachable helmet.

9. The switchable antenna system for the two-piece device according to claim 2, wherein the detachable host is worn on the body of a user via a strap.

10. The switchable antenna system for the two-piece device according to claim 1, wherein the two-piece device is a two-piece virtual reality device, a two-piece augmented reality device, or a two-piece mixed reality device.
